(19) United States
(12) Patent Application Publication
(10) Pub. No.: US 2008/0309125 A1
(43) Pub. Date: Dec. 18, 2008

(54) Train driver's cab comprising a canopy

(75) Inventors: Christophe Bodescot, Saint Jean De Liversay (FR); Eric Courcimeaux, Dompierre Sur Mer (FR)

Correspondence Address: Davidson, Davidson & Kappel, LLC, 485 7th Avenue, 14th Floor, New York, NY, 10018, US

(73) Assignee: ALSTOM TRANSPORT SA, LEVALLOIS-PERRET (FR)

(21) Appl. No.: 12/156,765

(22) Filed: Jun. 4, 2008

(30) Foreign Application Priority Data
Jun. 7, 2007 (FR) 07 55569

(51) Int. Cl. B62D 33/06

(52) U.S. Cl. 296/190.1

(57) ABSTRACT

A cab of this type comprises a frame (3) defining an internal volume (3a), the frame (3) having at least one upper opening (3b) for receiving panes of glass of said cab, said cab being wherein it comprises a canopy (2) forming an assembly in a single piece which is attached to the frame (3) so as to cover the upper opening (3b) and enclose the internal volume (3a), said canopy comprising a support frame (10) provided with side rails (11) defining at least two openings therebetween and at least two panes of glass (4, 5, 6) filling each opening respectively.

### TECHNICAL FIELD

The present invention relates to a driver's cab of a train or the like, of the type comprising a framework defining an internal volume, the framework having an upper opening for receiving the glazing of said cab.

### BACKGROUND TO THE INVENTION

In known train cabs of this type, the panes of glass, such as the windshield and the side bays, are mounted on the framework in succession and independently of one another. The cab is then equipped so as to have the desired aerodynamics and appearance, and a treatment is carried out around the glazing using an adhesive material to provide water- and air-tightness, since trains travelling at high speeds in tunnels are subjected to pressure waves.

The large panes of glass are stuck to the framework. The mechanical attachment of large glass elements is complex. The panes of glass have a complex shape and substantial thickness to match the shape of the cab and to be aerodynamically and aesthetically pleasing. Due to the geometric tolerances of the edges of the panes of glass and the corresponding supporting surfaces of the framework, it is difficult to fix such panes of glass to the framework by mechanical attaching means.

### SUMMARY OF THE INVENTION

An object of the invention is to propose a set of panes of glass, which can easily be mounted onto the cab and reduces the operations required for the construction of the cab.

The invention accordingly relates to a train driver's cab of the above-mentioned type, wherein it comprises a canopy forming an assembly in a single piece which is attached to the framework so as to cover the upper opening and enclose the internal volume, said canopy comprising a canopy frame provided with side rails defining at least two openings therebetween and at least two panes of glass covering each opening respectively.

Since the canopy forms an assembly which is mounted in one piece on a train cab, the canopy can and the cab framework can be mounted apart from one another, making the mounting of the cab easier.

Furthermore, equipment can be mounted onto the cab prior to attachment of the canopy by passing said equipment through the wide opening for receiving the canopy, thereby further simplifying the mounting.

The cab and the canopy may be further equipped with an inner lining, equipment and electrical cables, for example, prior to the assembly of the canopy on the framework.

If necessary, it is possible to change the panes of glass one by one without having to disassemble the whole canopy, since they are attached by means of a detachable frame which is part of the canopy. Replacement of the panes of glass is therefore quick and effective, and the train is more readily serviceable than trains with stuck panes which require a significant drying time before the train is available again.

According to other embodiments, the canopy has one or more of the following features, considered individually or in any technically feasible combinations:

the canopy comprises all the fixed panes of glass of the cab;

the canopy comprises all the panes of glass of the cab;

the canopy frame comprises a skin made of an impermeable composite material;

the periphery of each pane of glass is attached to the side rails of the support frame by mechanical attaching means;

each pane of glass is surrounded by a metal frame forming the periphery of said pane, said frame being attached to the side rails by mechanical attaching means;

a metal sole piece is attached to the side rails of the support frame, the periphery of each pane of glass being attached to said sole piece by mechanical attaching means;

the composite lining material comprises polyester;

the canopy is in the form of a dome; and

sealing means are disposed between the periphery of each glazing and the support frame.

### BRIEF DESCRIPTION OF THE DRAWINGS

Other aspects and advantages of the invention will emerge from the following description which is given by way of example and refers to the accompanying drawings, in which:

FIG. 1 is a partial perspective view of a train driver's cab according to the invention, the canopy being separate from said cab,

FIG. 2 is a cross-section of the canopy along the axis II-II in FIG. 1, the canopy being mounted on the framework,

FIG. 3 is a partial cross-section of the canopy along the axis III-III in FIG. 1, the canopy being mounted on the framework,

FIG. 4 is a partial cross-section of the zone IV in FIG. 1, the canopy being mounted on the framework.

### DESCRIPTION OF PREFERRED EMBODIMENTS

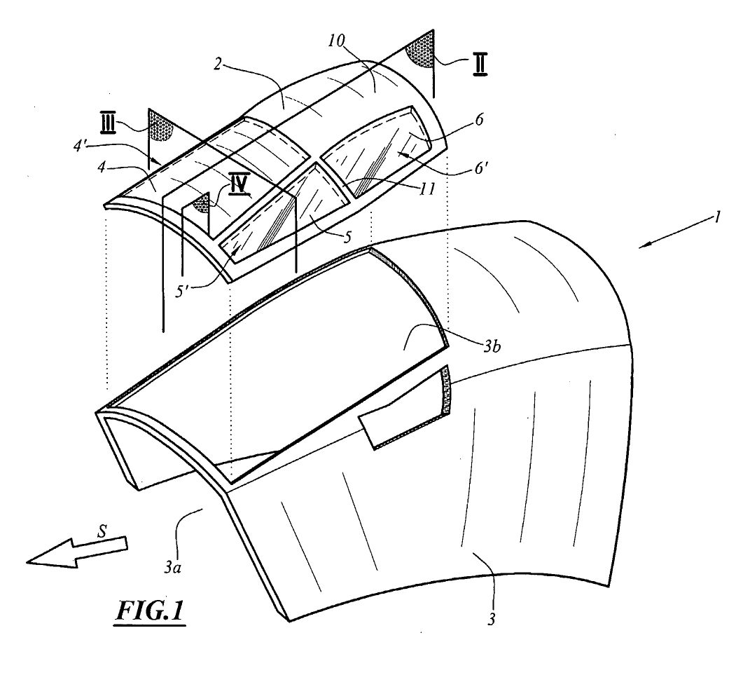

FIG. 1 shows a part of a driver's cab 1 of a train, in particular a high-speed train, comprising a canopy intended to be attached to a framework 3 of the cab 1. The framework 3 and the canopy 2 may therefore be made apart from one another.

In the description which follows, the words “front”, “rear”, “left”, “right”, “longitudinal”, “transverse”, “upper” and “lower” are understood to refer to the direction of travel of the vehicle in forward motion shown by the arrows in FIG. 1.

The framework 3 defines an internal volume 3a in which equipment may be mounted prior to attachment of the canopy 2 to the framework. The framework 3 comprises an upper opening 3b which is covered by the canopy 2 when said canopy 2 is attached so as to enclose the internal volume 3a. Mounting of the driver's cab is therefore simple. The canopy is attached to the framework 3 by attaching means (not shown) extending, for example, at the periphery of the canopy 2 and at the periphery of the opening 3b.

The canopy 2 comprises the set of panes of glass 4, 5, 6 which are required to give the train driver good visibility. According to the embodiment shown in the figures, the canopy comprises a windshield 4 disposed in the centre of the canopy 2, two front side apertures 5 disposed to the right and left of the windshield 4 respectively, and two rear side apertures 6, disposed adjacent to and to the rear of the front side apertures 5, as shown in FIG. 1.

According to one embodiment, the canopy comprises all the fixed panes of glass of the driver's cab. The word “fixed” refers to panes of glass which are “not openable”, in other words, panes of glass which are permanently attached to the cab. In this embodiment, the openable panes of glass, in other words windows, which allow communication between the inside of the cab and the outside of the train, are provided on the framework of the driver's cab to allow the train-driver to communicate with staff on the platform, for example.

According to one embodiment, the canopy comprises all the panes of glass of the cab and no pane of glass is provided on the framework of the driver's cab.

The panes of glass 4, 5, 6 have a substantial thickness, for example of between 25 mm and 40 mm, are large (the windshield is between 1.3 m and 1.6 m long and between 1.2 m and 1.6 m wide, for example) and have a complex three-dimensional shape (variable thickness, profiled cut-out and non-planar surface, concave surface of the panes of glass, for example). The weight of the panes of glass is also substantial (the windshield weighs approximately 150 kg, for example). These panes of glass 4, 5, 6 are known and are used in particular in high-speed trains.

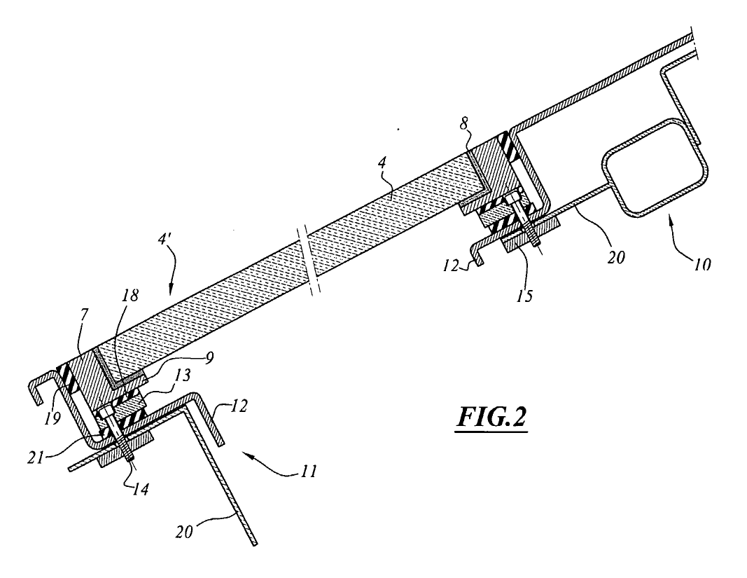

The periphery of each pane of glass 4, 5, 6 is fitted with a frame 7 to which the pane of glass is, for example, stuck by means of a layer of mastic 8. The assembly formed by a pane of glass 4, 5, 6 and a frame 7 is called window 4′, 5′, 6′ respectively. The frame 7 is made of a metal, for example aluminium. Each L-shaped frame 7 extends along the edges of each pane of glass 4, 5, 6 and supports said pane of glass 4, 5, 6. Each frame 7 comprises an arm 9 extending under said edges on the surface of the pane of glass which is intended to be located on the inner part of the cab 1, as shown in FIGS. 2 to 4.

The canopy 2 comprises a canopy frame 10 to which the windows 4′, 5′, 6′ are attached by means of the respective frame 7 thereof. The canopy frame 10 comprises side rails 11 delimiting openings filled by a window 4′, 5′, 6′ respectively. The canopy frame 10 is formed of a skin 12 made of a composite material and reinforced by a reinforcing framework 20 made of metal. The composite material comprises polyester, for example. The skin 12 allows the canopy 2 to be sealed and provides said canopy with a resistance to pressure waves which occur particularly when the train runs at high-speed through a tunnel.

A sole piece 13 is attached to the upper face, which is intended to be located on the outside of the cab, of the side rails 11 of the support frame 10 using mechanical attaching means 14 such as screws. The sole piece 13 is made of a metal such as aluminium. The sole piece 13 is held on the side rail 11 by tightening the screw 14 into a base plate 15 disposed under a side rail 11.

The frame 7 for the windows 4′, 5′, 6′ is thus attached to the sole piece 13 by mechanical attaching means 16 such as screws, as shown in FIG. 4. The screw 16 passes through the frame 7 and is screwed into the sole piece 13. A stopper 17 is, for example, provided to plug the hole in the frame 7 through which the screw passes, in order that the canopy has a smooth upper surface to improve the aerodynamics of the assembly.

The windows 4′, 5′, 6′ are therefore mechanically attached to the canopy frame 10, and this provides a mechanical resistance to the aerodynamic effects and allows quick disassembly which cannot be achieved if the panes of glass are attached directly onto the side rails 11 using glue.

Furthermore, this method of attaching the windows 4′, 5′, 6′ to the canopy frame 10 by means of a sole piece 13 allows the frame 10 to be permanently attached to the framework 3, only one window 4′, 5′, or 6′ needing to be changed if said window breaks by removing the frame 7 from the sole piece 13.

Sealing means 18, 19, 21 are provided between the periphery of each pane of glass 4, 5, 6 and the support frame 10.

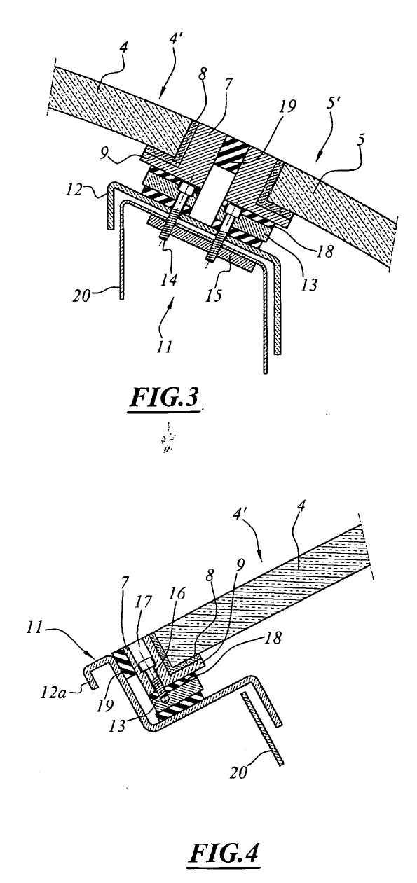

At the joint between the windshield 4 and the front apertures 5, the periphery of these panes of glass is connected to the support frame 10 as previously mentioned and the frames 7 of these panes of glass are spaced apart one from the other by sealing means 19, as shown in FIG. 3.

The canopy 2 thus produced forms a dome-shaped assembly which is attached in one piece to the framework 3, as shown in FIG. 1. The shape of the domed canopy is aerodynamically suited to a train driver's cab 1. Therefore, when the canopy 2 is attached to the framework 3, the skin 12 is flush with the skin of the cab 1 to ensure optimum aerodynamics of the assembly.

1-10. (canceled)

11. A driver's cab for a train or the like comprising:
a framework defining an internal volume, the framework having an upper opening for receiving panes of glass of the cab;
a canopy forming an assembly in a single piece attached to the framework so as to cover the upper opening and enclose the internal volume, the canopy including a canopy frame provided with side rails defining at least two openings therebetween and at least two of the panes of glass filling each opening respectively.

12. The driver's cab according to claim 11 wherein the canopy includes all the fixed panes of glass of the cab.

13. The driver's cab according to claim 11 wherein the canopy includes all the panes of glass of the cab.

14. The driver's cab according to claim 11 wherein the canopy frame includes a skin made of an impermeable composite material.

15. The driver's cab according to claim 11 wherein a periphery of each pane of glass is attached to the side rails via a mechanical attachment.

16. The driver's cab according to claim 11 wherein each pane of glass is surrounded by a metal frame forming a periphery of the respective pane of glass, the frame being attached to the side rails via a mechanical attachment.

17. The driver's cab according to claim 11 wherein a metal sole piece is attached to the side rails of the support frame, a periphery of each pane of glass being attached to the sole piece via a mechanical attachment.

18. The driver's cab according to claim 11 wherein the canopy frame includes a lining made of a composite material including polyester.

19. The driver's cab according to claim 11 wherein the canopy is in the form of a dome.

20. The driver's cab according to claim 11 wherein a seal is disposed between a periphery of each pane of glass and the canopy frame.
